(19) United States
(12) Patent Application Publication
(10) Pub. No.: US 2003/0011676 A1
(43) Pub. Date: Jan. 16, 2003

(54) Environmental imaging apparatus and method

(76) Inventors: Andrew Arthur Hunter, Bristol (GB); Stephen Bernard Pollard, Uley Nr Dursley (GB); Stephen Philip Cheatle, Bristol (GB); Glenn Peter Hall, Stroud (GB)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/188,315

(22) Filed: Jul. 3, 2002

(30) Foreign Application Priority Data
Jul. 4, 2001 (GB) 0116300.5

(51) Int. Cl. H04N 7/00

(52) U.S. Cl. 348/119; 348/159; 348/169

(57) ABSTRACT

Image capturing apparatus comprises plural image capture devices at spaced-apart intervals along plural routes. A selector selects a navigation path including at least a portion of one or more of the routes. An image processor sequentially combines one or more image frames from each of a plurality of the image capture devices to produce an image sequence which, when viewed at a suitable rate, simulates motion along said selected navigation path. A method for producing an image sequence which, when viewed at a suitable rate, simulates motion along a selected navigation path is also provided.

### FIELD OF THE INVENTION

This invention relates generally to environmental imaging apparatus and, more particularly, to environmental imaging apparatus for use in many different circumstances to investigate or view conditions over a relatively long distance, which is not viewable using a single static environmental camera.

### BACKGROUND TO THE INVENTION

Over recent years, it has become increasingly common to provide a number of surveillance cameras or similar image capturing devices at spaced-apart intervals within an area or along a route to enable relevant conditions there to be monitored (in real time) or recorded (for possible future reference). For example, it is particularly common for cameras to be deployed along busy trunk roads and the like, to monitor traffic conditions etc.

The images captured by some of these cameras are available to members of the general public via the Internet, and cameras can be used, for example, to judge traffic conditions at one or more specific points along a predetermined route or weather conditions at a particular destination.

However, each camera has a predefined field of view, beyond which images cannot be captured (without adjusting or moving the camera). In order to view the images being captured elsewhere within a specified area or along a particular route, the user must access the images captured by another suitable camera and there is inevitably a gap or ‘blind spot’ between the scenes in captured images.

Another known system comprises a plurality of cameras which are mounted in spaced around relation around a predefined area, for example a sports stadium or the like. Each of the cameras is directed toward the area of interest so that images of a single subject can be captured from more than one camera angle. These true images can then be used to create an image of the subject apparently captured from a virtual camera angle, i.e. images of a subject captured using two or more cameras at different angles relative to the subject, can be used to “predict” the image of the subject which would be captured from another angle relative to the subject, at which there is no camera actually present. This system therefore enables an operator to “move” a camera in virtual space.

A similar type of known system employs a technique known as “time slice photography”, and employs a plurality of cameras which are mounted on a rig around a subject. The cameras are triggered substantially simultaneously to capture images of the subject at different respective angles relative thereto. The captured images can then be played back in predetermined sequence to give the appearance that the subject is “frozen” in time, and a single camera is panning around the frozen subject. Although the cameras as generally mounted on the rig in a line, they all face in towards the subject, i.e. they could not face each other in one direction or the other because each camera would dominate the image captured by the adjacent camera.

Each of the above two known arrangements are generally only suitable for use in an enclosed or predefined local space.

Route planning systems also exist, in which a user can enter their current location and a desired destination, and the route-planning system provides one or more recommended/possible routes therebetween. However, the output of such systems tends to be a set of directions or, at best, a map to be followed by the user. There is no provision for the user to investigate factors such as weather conditions, traffic problems etc. prior to commencing or during their journey.

There are many situations in which it might be required to investigate conditions along a route, such as a road, footpath, corridor, pipeline etc., or a network of such routes, the extend of which would not be visible from a single position, and none of the prior art systems described above would be capable of achieving this.

Japanese patent specification JP2001-103451-A describes an image capture and processing system for monitoring traffic conditions in a tunnel. The system comprises a plurality of cameras mounted in spaced apart relation along the tunnel, and a central processing apparatus for receiving images captured by the cameras and displaying the images sequentially to give the impression of a single (virtual) camera moving along the whole tunnel. The speed and direction of the “scan” can be defined and altered by the user. However, the described system relates to a single predetermined route through a tunnel, and it does not enable a user to navigate any other routes connected to that tunnel, nor does it enable the user to select a portion of the predetermined route provided by the system.

We have now devised an improved arrangement.

### SUMMARY OF THE INVENTION

In accordance with a first aspect of the present invention, there is provided image capturing apparatus comprising a plurality of image capture devices at spaced-apart intervals along a plurality of routes, selection apparatus for selecting a navigation path comprising at least a portion of one or more of said routes, and an image processor for sequentially combining one or more image frames from each of a plurality of said image capture devices located along said selected navigation path to produce an image sequence which, when viewed at a suitable rate, simulates (preferably substantially continuous) motion along said selected navigation path. The simulated motion is preferably substantially continuous.

Also in accordance with the first aspect of the present invention, there is provided a method of producing an image sequence which, when viewed at a suitable rate, simulates (preferably substantially continuous) motion along a selected navigation path, the method comprising the steps of providing a plurality of image capture devices at spaced-apart intervals along a plurality of routes, selecting a navigation path comprising at least a portion of one or more of said routes, and sequentially combining one or more image frames captured by each of a plurality of image capture devices located along said navigation path to produce said image sequence.

In accordance with a second aspect of the present invention, there is provided navigation apparatus comprising a plurality of cameras at spaced-apart intervals along a network of routes, at least one of said routes branching from, joining to or crossing one of the other routes in said network such that said network includes one or more junctions, selection apparatus for selecting a navigation path within said network, said navigation path comprising a plurality of routes, said selection apparatus being arranged to enable a user to select one of a plurality of possible routes at said one or more junctions, image processing apparatus for sequentially combining one or more image frames from each of a plurality of said camera located along a selected navigation path to produce an image sequence, and a display for displaying said image sequence to simulate substantially continuous motion along the selected navigation path.

In accordance with a third aspect of the present invention, there is provided route planning apparatus comprising image processing apparatus for receiving image frames from a plurality of cameras located at spaced-apart intervals along one or more routes and selection apparatus for selecting one of said routes or a portion of one of said routes, on which a user intends to travel, the image processing apparatus being arranged to combine image frames from cameras located along the selected route or portion of a route to produce an image sequence, the apparatus further comprising a display for displaying said image sequence such that conditions on said route or said portion of a route can be determined prior to said user travelling thereon.

Thus, in general, the present invention supports arbitrary and unlimited end-to-end navigation, which is particularly useful in a preferred embodiment of the invention in which the plurality of routes consist of a number of paths (or “sub-routes”), at least some of which branch from, join to or cross one or more of the other paths. In other words, the present invention enables arbitrary end-to-end navigation of an unlimited number of sequences of parts of a network of routes—for example, if the parts are connected as a loop, such navigation can include any number of turns around that loop. It is the ability to select a navigation path from a wide variety of potential paths which affords the present invention a number of advantages over the prior art. In theory, at least, there are a number of different ways to navigate through a network, any or all of which can be selectively supported by the apparatus and method of the present invention.

More specifically, the present invention provides apparatus and a method for enabling a user to investigate a selected navigation path consisting of at least a part of one or more routes. For the avoidance of doubt, a “route” is intended to include roads, footpaths, corridors, pipelines or any other type of path along which something can travel. It is also intended to include a network or series of such paths. Among others, advantages of the present invention include the ability to investigate a relatively long route using images captured in real time. Thus, in the car where a proposed car journey is being investigated, the journey can be rehearsed in a matter of minutes, which rehearsal would include easily recognisable and significant features which can be expected to be seen en route, current weather and traffic conditions etc.

### BRIEF DESCRIPTION OF THE DRAWINGS

The present invention will now be described by way of example only and with reference to the accompanying drawing, which is a schematic block diagram of apparatus according to an exemplary embodiment of the present invention.

### DETAILED DESCRIPTION OF THE INVENTION

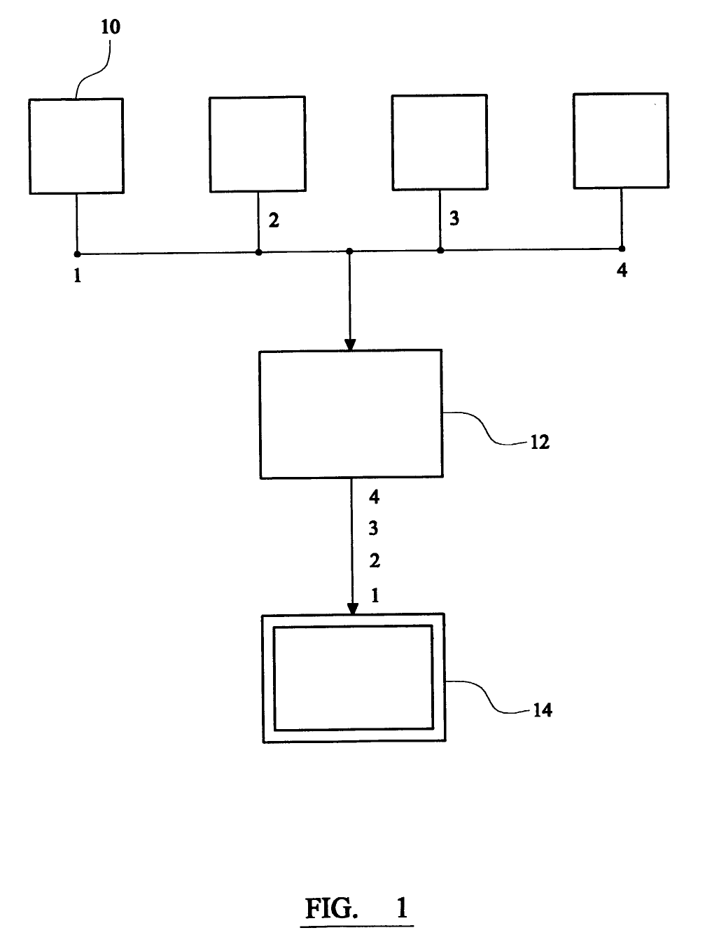

Referring to FIG. 1, an exemplary embodiment of image capturing apparatus according to the invention comprises a plurality of image capture devices 10, such as digital video cameras, deployed at intervals of approximately 40 metres on both carriageways of a motorway (not shown) pointing in the direction of traffic flow. The apparatus further comprises a single access point 12, such as a website, and display means 14 (which may, for example, be part of the personal computing apparatus by means of which a user accesses the website). It should be noted that the image processing control means required to operate the present invention might be at the access point, or distributed between the cameras 10, or separate from both, perhaps located between the cameras 10 and the access point 12.

It should also be noted that the display 14 could be at the access point 12 or remote therefrom; for example, the access point 12 might be a website and the display means 14 may be a portable display terminal.

In use, a user logs onto the website and selects a route, the apparatus then accesses each of a sequence of adjacent cameras 10 along the chosen route substantially simultaneously, thereby creating a sequence of image frames in the order in which the cameras are located along the route, depending on the chosen direction of travel, and plays or transmits the sequence at, say 25 frames per second, for display on the display means 14 to give the viewer the impression of relatively high speed motion along the route.

Of course, the rate of simulated motion along the route may be prescribed by the user (either in advance or en route), interactively defined according to the user's actions (as in, for example, a driving simulation), or determined by prediction/extrapolation of real motion of, for example, a vehicle on a motorway.

In a preferred embodiment of the invention, a single image frame captured by each of a sequence of image capture devices is combined in a sequence and viewed at a suitable frame rate to simulate continuous motion along a route.

In a preferred embodiment of the invention, the image capturing devices are preferably oriented substantially in the direction of the next camera in sequence (depending on the direction in which travel is required to be simulated.

The image capturing devices may comprise still image cameras, or video cameras which may be triggered as required or they may be arranged to generate a continuous sequence of frames which can be selected as required. The cameras may comprise traffic/security cameras already deployed for another purpose, or they may have a dual function so that they can be deployed for whatever purpose is required at any particular time.

Image capture devices, such as publicly accessible digital video cameras, could be deployed at intervals of, for example, approximately 40 metres (perhaps in or on lamp posts or the like) on both carriageways of a motorway (pointing in the direction of traffic flow). One frame from each of a sequence of adjacent cameras are combined and played back at a frame rate of, for example, 25 frames (or video fields) per second which, when displayed, gives the viewer the impression of continuous high speed motion along the motorway in the chosen direction. By such means using this frame rate, a five hour motorway journey could be ‘rehearsed’ in around ten minutes. Unlike a road map, such a rehearsal could show real traffic conditions, recognisable landmarks, actual road signs, weather conditions en route, etc, especially if live data were used to produce such a ‘fly-through’ image sequence.

In the event that a network of routes is required to be investigated, the route taken by the system at each branch of said network may be predefined (because the user has chosen a specific route or destination), user-selectable at each junction, predicted by the system according to some criteria, or determined by some other factor and of the user's control, such as the case where he is following the progress of another vehicle and is therefore obliged to follow the route taken by that vehicle. Thus, although a network of connected routes is predetermined by the deployment of suitable cameras, a user can follow an arbitrary sequence of routes within the network that cannot necessarily be predetermined. Thus, the term “navigation path” is intended to convey an arbitrary and selected (according to whatever criteria) route or sequence of routes.

In the apparatus of the present invention the selection apparatus may be arranged to select a complete navigation path prior to producing and viewing the image sequence; and/or initially select a partial navigation path, and select, while motion along that partial navigation is being simulated or when such motion has been simulated, one or more further routes in addition to the partial navigation path, so as to enable interactive simulated navigation by a user along the selected routes defining a navigation path; and/or the selection apparatus may include input means for enabling a user to input end points of a selected navigation path, and be arranged to determine a suitable navigation path between the end points; and/or the selection apparatus may include a tracking system for tracking the progress of a person or object along one or more of the routes and be arranged to define the navigation path along which motion is to be simulated according to the route(s) followed by the person or object.

In the case of a network, at branches or crossovers of routes, multiple cameras may be provided, perhaps one per route through the junction. Alternatively, the cameras deployed may have fields of view wide enough that different angles required to follow different routes through a junction can be supported by cropping appropriate regions of the respective views (perhaps at the same time).

It will be appreciated that the same image capture devices can be used for more than one simulated journey at a time (maybe even for multi-player games).

Similar simulated motion along urban roads, around town centres and along tourist paths/routes for example, could also be achieved, but may require a greater density of deployed cameras. In general, the slower the motion required to be simulated, the greater the density of cameras required to be deployed in order to ensure substantially continuous simulated motion.

The image capture devices are preferably relatively small and a sufficient distance apart such that the field of view of one camera is not dominated by the adjacent camera.

In any event, the method and apparatus of the present invention would enable, for example, journeys to be planned and rehearsed, and could even enable virtual tourism as an end in itself, i.e. allow people to simulate a visit to and around a tourist destination and see all the sights, without actually visiting the destination itself. In another embodiment, the present invention could be used to track the progress of, for example, friends and family as they make a journey.

In one embodiment of the present invention, the apparatus may comprise means for addressing each of a sequence of adjacent image capture devices independently, taking a live image frame from each to produce an image sequence and then playing the sequence at a predetermined frame rate for display. In a preferred embodiment, the present invention may comprise a single point of access, for example via a motorway website or the like, to which a frame from each of a sequence of adjacent image capture devices is transmitted on request or automatically periodically transmitted and stored for use on request, formed into an image sequence, played back at a suitable frame rate and displayed to the user.

The set of image frames forming the sequence may be captured substantially simultaneously. Alternatively, the frames could be captured at spaced-apart time intervals, with the time interval between capturing the first and last image frames being substantially equal to the duration of the sequence during playback.

One embodiment of the present invention may comprise route-finding means, whereby the user inputs a current location and intended destination, the apparatus would then include means for determining the only or shortest or best route from the user's current location to their chosen destination, and display a ‘fly-through’ of the journey, as discussed above. It should be noted that software is available to perform ‘fly-throughs’ in, for example, buildings for use by architects and the like. However, such software does not employ true images of the building interior (either live or recorded), it uses images simulated by the software according to user input.

The spacings between image capture devices may be substantially equal, but in any event should be known so that the frame rate at which a sequence is played back can be set to ensure simulation of substantially continuous motion, or smooth acceleration of deceleration, as required.

In one exemplary embodiment of the present invention, if the number and/or position of image capture devices deployed in a sequence is insufficient to collectively capture images covering the whole of an area or route so that there are ‘blind spots’ in the resultant image sequence, the apparatus may comprise means for storing still intermediate image frames for insertion between image frames captured by the adjacent image capture means to complete the image sequence.

Alternatively, known image processing techniques can be used to generate intermediate frames for insertion into a sequence to give a greater frame rate. In one known technique, images captured by two adjacent cameras can be used to “predict” images which would be captured by cameras if they were positioned between those adjacent cameras. In one embodiment of the invention, this might be achieved using a technique known as “morphing” which involves identifying points of correspondence between the two true images to generate one or more “predicted” virtual images. This technique actually has the effect of generating an image which comprises an enlarged section of the image captured by one of the cameras, and reduced version of the image captured by the adjacent camera in the sequence.

Thus, the cameras and system may be arranged so that simple interpolation methods can be used to generate intermediate frames of a sequence, using only a relatively small number of points of correspondence. However, in order to achieve the same desired effect at sharp bends in a route, a relatively large number of cameras would need to be deployed.

Alternatively, or additionally, more sophisticated interpolation techniques could be employed, whereby a relatively large number of points of correspondence are used to generate one or more intermediate frames from a single image, or to morph two images to form images depicting points on the route between the two respective cameras. In a very advanced system, a three-dimensional model of the views from the cameras could be used to construct a new synthetic image at an intermediate point on the route.

Morphing using points of correspondence can also be used to adapt the tones and colours of images in a sequence (whether true or virtual) so that the images are combined effectively and smooth transition from one camera view to another is ensured. Otherwise, the smoothness of the sequence may be adversely affected by changes in lighting conditions, exposure conditions of individual cameras etc. over time which affect the tones and colours appearing in the resultant images.

In one embodiment of the invention, image capture devices may be placed at intervals along both sides of a route (substantially opposite each other). The interpolation techniques described above could be used to “predict” the view in each of a plurality of lanes between each pair of corresponding image capturing devices, so that the user can interactively change lanes along a route to simulate real driving conditions (in, for example, a driving training system or computer game), or observe the changes recommended by a route-planning system.

The system may be arranged to simulate acceleration/deceleration of motion along the route, as required, in which case the number of virtual images used in a sequence could be decreased/increased accordingly, to ensure smooth simulated motion, especially at lower speeds.

Of course, in another embodiment, the image capturing devices may have the ability to zoom in along its field of view so that true intermediate images can be captured.

The system may comprise means for altering the field of view of an image capture device (preferably gradually to ensure a smoother transition) so that the user can achieve a better view of an object, such as a sign post, which is relatively wide of the centre of the field of view.

Audio data may be provided which is associated with one or more locations along a route or navigation path, which audio data may be caused to play and/or be faded in and out as the simulated motion approaches and then passes those one or more locations.

It will be appreciated that at least some of the image capture devices could include other types of sensors, such as microphones, so that sounds can also be recorded and played back, the sounds being faded in and out as dictated by the simulated motion.

Means are preferably provided to display and/or record images captured by the image capturing devices so as to simulate motion along the sequence of image capture devices by playing back said images in sequence at a suitable frame rate.

The display means may comprise a portable display system which functions as a route planner for, for example, a pedestrian to plan a course through a busy network of streets (or footpaths or corridors etc). Such functions may be provided in a stand-alone device, or as part of an existing device, such as a PDA.

The display means may, alternatively, be provided in a vehicle for use by a driven passenger of said vehicle to view the route ahead (or behind) and fixed at variable positions, so that they can, for example, investigate the route around the next bend in the road, look ahead to the next junction of a motorway, look ahead to see what is causing a hold-up in traffic and/or how long a delay may be so that the driver can judge whether or not to exit the current route and avoid the delay, if possible.

A lot of this specification refers to simulating motion along a road or footpath. However, investigation of many other routes using the system of the invention are envisaged. For example, a fire safety officer may be required to check every day that all routes to fire exits in a building are clear. Using the system of the invention, each route can be checked quickly, efficiently and reliably (using images captured by existing security cameras, if required). Similarly, a security guard could use the system of the present invention to perform a periodic sweep of a building to check for intruders.

Although the present invention has been described by way of examples of a preferred embodiment, it will be evident that other adaptations and modifications may be employed without departing from the scope of the invention as defined by the appended claims. Further, the terms and expressions employed herein have been used as terms of description and not of limitation; and, thus, there is no intent to exclude equivalents, but on the contrary it is intended to cover any and all equivalents which may be employed without departing from the scope of the invention as defined by the appended claims.

1. Image capturing apparatus comprising a plurality of image capture devices at spaced-apart intervals along a plurality of routes, selection apparatus for selecting a navigation path comprising at least a portion of one or more of said routes, and an image processor for sequentially combining one or more image frames from each of a plurality of said image capture devices located along said selected navigation path to produce an image sequence which, when viewed at a suitable rate, simulates motion along said selected navigation path.

2. Navigation apparatus comprising a plurality of cameras at spaced-apart intervals along a network of routes, at least one of said routes branching from, joining to or crossing one of the other routes in said network such that said network includes one or more junctions, selection apparatus for selecting a navigation path within said network, said navigation path comprising a plurality of routes, said selection apparatus being arranged to enable a user to select one of a plurality of possible routes at said one or more junctions, image processing apparatus for sequentially combining one or more image frames from each of a plurality of said cameras located along a selected navigation path to produce an image sequence, and a display for displaying said image sequence to simulate substantially continuous motion along the selected navigation path.

3. Apparatus according to claim 1, comprising means for selecting a complete navigation path prior to producing and viewing said image sequence.

4. Apparatus according to claim 2, wherein said selection apparatus is arranged to enable a user to initially select a partial navigation path and subsequently to select, while in motion along said partial navigation path is being simulated or after such motion has been simulated, one or more further routes in addition to said partial navigation path, thereby enabling interactive simulated navigation by a user along said selected routes.

5. Apparatus according to claim 1, comprising an input terminal for enabling a user to input end points of a selected navigation path, and apparatus for determining a suitable navigation path between said end points.

6. Apparatus according to claim 2, comprising a tracking device for tracking the progress of a person or object along one or more of said routes and apparatus for defining the navigation path along which motion is to be simulated according to the route(s) followed by the person or object.

7. Image capturing apparatus according to claim 1, wherein a single image frame captured by each of a sequence of image capture devices is combined sequentially and viewed at a predetermined frame rate to simulate substantially continuous motion along a selected navigation path.

8. Image capturing apparatus according to claim 1, wherein said image capture devices comprise digital video cameras.

9. Image capturing apparatus according to claim 8, wherein said image capture devices comprise publicly-accessible digital video cameras.

10. Apparatus according to claim 1, wherein the image processing apparatus is arranged to interpolate image frames captured by two or more image capture devices to enable said simulated motion to simulate lane changing, for example, along a route.

11. Apparatus according to claim 1, including a system for providing audio data associated with one or more locations along a navigation path.

12. Apparatus according to claim 11, wherein said audio data is caused to be played and/or faded in and out as said simulated motion approaches and then passes the or each said locations along said navigation path.

13. Apparatus according to claim 2, including a portable display screen for viewing said simulated motion.

14. Route planning apparatus comprising image processing apparatus for receiving image frames from a plurality of cameras located at spaced-apart intervals along one or more routes, and selection apparatus for selecting one of said routes or a portion of one of said routes on which a user intends to travel, the image processing apparatus being arranged to combine image frames from cameras located along the selected route or portion of a route to produce an image sequence, the apparatus further comprising a display for displaying said image sequence such that conditions on said route or said portion of a route can be determined prior to said user travelling thereon.

15. Apparatus according to claim 1, comprising a processor arrangement for addressing each of a sequence of adjacent image capture devices independently, and for taking a live image frame from each to produce an image sequence and then playing the sequence at a suitable frame rate for display.

16. Apparatus according to claim 1, comprising a single point of access, to which a frame from each of a sequence of adjacent image capture devices is transmitted on request or automatically periodically transmitted and stored for use on request, formed into an image sequence, played back at a predetermined frame rate and displayed to the user.

17. Apparatus according to claim 16 wherein the single point of access includes a website.

18. Route-finding apparatus comprising image capturing apparatus according to claim 2, and comprising a system to enable a user's current location and intended destination to be entered, and for determining a suitable navigation path from the user's current location to their intended destination, the image processing apparatus being arranged to create and display an image sequence of a proposed journey between said current location and said intended destination.

19. Apparatus according to claim 1, further comprising a store for storing still image frames for insertion between or addition to the sequence of image frames captured by the adjacent image capture means.

20. Apparatus according to claim 1, further comprising a processor arrangement for generating a virtual image representative of an image which would be captured by an image capturing device located between two adjacent image capturing devices, said virtual image being for insertion between or addition to the sequence of image frames captured by said image capture devices.

21. A method for producing an image sequence which, when viewed at a suitable rate, simulates motion along a selected navigation path, the method comprising the steps of capturing a plurality of images at spaced-apart intervals along a plurality of routes, selecting a navigation path including at least a portion of one or more of said routes, and sequentially combining one or more of the captured image frames located along said navigation path to produce said image sequence.

22. The method according to claim 21, wherein said plurality of routes includes a number of paths, at least some of which branch from, join to or cross one or more of other of said paths.

23. The method according to claim 21, including the step of selecting a complete navigation path prior to producing and viewing said image sequence.

24. A method according to claim 21, including the steps of initially selecting a partial navigation path, and selecting, while motion along said partial navigation path is being or has been simulated, one or more further routes in addition to said partial navigation path, thereby enabling interactive simulated navigation by a user along said selected routes.

25. A method according to claim 21, including the step of determining a suitable navigation path between two or more predefined end points.

26. A method according to claim 21, including the steps of tracking the progress of a person or object along one or more of said routes and defining the navigation path along which motion is to be simulated according to the route(s) followed by the person or object.

27. A method according to claim 21, comprising the steps of combining in a sequence a single image frame of each of the captured sequence of captured images and viewing at a predetermined frame rate to simulate continuous motion along said selected navigation path.

28. A method according to claim 21, including the steps of addressing each of a sequence of adjacent captured images independently, taking a live image frame from each to produce an image sequence and then playing the sequence at a suitable frame rate for display.

29. A method according to claim 21, comprising the step of transmitting a frame from each of a sequence of adjacent captured images to a single access point, forming said transmitted frames into an image frame sequence, playing back said frame sequence at a suitable frame rate and displaying the resultant image sequence to the user.

30. A method according to claim 21, including the step of interpolating two or more captured image frames so as to simulate lane changing.

31. A method according to claim 21, including the step of providing audio data associated with one or more locations along a navigation path.

32. A method according to claim 31, including the step of causing said audio data to be faded in and out as said simulated motion approaches and then passes the or each said locations along said navigation path.

33. A method according to claim 31, including the step of causing said audio data to be played as said simulated motion approaches and then passes the or each said locations along said navigation path.

34. A method according to claim 21, including the step of simulating motion along a portion of a navigation path on which a user is travelling or plans to travel, prior to the user reaching said portion of said navigation path.

35. A method according to claim 21, further comprising the step of storing still intermediate image frames for insertion between or addition to adjacent captured image frames to substantially complete the image sequence, if necessary.

36. A method according to claim 21, further comprising the step of generating a virtual image representative of an image which would be captured at a location between two adjacent sites where the images are captured, said virtual image being for insertion between or addition to image frames captured at the adjacent image capturing sites.
